(19) United States
(12) Patent Application Publication
(10) Pub. No.: US 2012/0002278 A1
(43) Pub. Date: Jan. 5, 2012

(54) Anti-Moire Optical System and Method

(75) Inventors: Thomas Zerega, New York, NY (US); James Zahakos, New York, NY (US); Barret Lippey, Belmont, MA (US)

(73) Assignee: MAGNETIC MEDIA HOLDINGS, INC., New York, NY (US)

(21) Appl. No.: 13/172,725

(22) Filed: Jun. 29, 2011

Related U.S. Application Data
(60) Provisional application No. 61/359,838, filed on Jun. 30, 2010.

(51) Int. Cl. G02B 27/22; G02F 1/1335; G02B 27/12

(52) U.S. Cl. 359/463; 359/619; 349/95

(57) ABSTRACT

A three-dimensional optical display system and method that reduces moiré patterns formed between the image display panel and a 3D lens. The reduction of moiré patterns may be achieved by adding a lenticular anti-moiré lens or by curving the 3D lens into a convex shape. The anti-moiré lens may have a regular period, or may incorporate random elements.

### BACKGROUND OF THE INVENTION

Autostereoscopic 3D displays provide realistic three-dimensional images without the use of eyewear. A left-eye image is sent to the left eye and right-eye image is sent to the right eye. The left-eye image and right-eye image simulate the images that would be seen by each eye when viewing the original object. A mask prevents the left eye from seeing the right-eye image and vice versa. The mask may be formed from a 3D lens which may be a lenticular lens, parallax barrier, or equivalent optical element. A lenticular lens consists of a linear array of lenticules, each lenticule forming an individual lens. An image display panel such as a liquid crystal display (LCD) panel may be used to display still or moving images and the 3D lens may be placed in front of the display to provide 3D imaging. Degradation of the images may occur if visible Moiré patterns are created from the interaction between the periodic pattern of an LCD panel and the periodic pattern of a 3D lens

### SUMMARY OF THE INVENTION

In general, in one aspect, an optical system including an image display panel and an anti-moiré lens positioned in front of the image display panel. The anti-moiré lens comprises a lenticular lens.

Implementations may include one or more of the following features. There may be a 3D lens positioned in front of the anti-moiré lens. The 3D lens may include a lenticular lens. The anti-moiré lens may be laminated to the back of a plate and the 3D lens may be laminated to the front of the plate. The image display panel may include a liquid crystal display. The anti-moiré lens may include a periodic array of lenticules and the lenticules may have a radius “r” in microns and a pitch “a” in microns, the image display may have a pixel pitch “p” in microns, and “r” may be between 0.004 pa and 0.1 pa or more specifically “r” may be equal to 0.02 pa. The lenticules may be oriented substantially vertically. The anti-moiré lens may include a periodic array of lenticules, each lenticule having a flat surface, and each flat surface having an angle in the range of 0.5 to 5 degrees. The anti-moiré lens may include a random array of lenticules, each lenticule having an average radius “r” in microns and an average pitch “a” in microns, the image display may have a pixel pitch “p” in microns, and “r” may be between 0.004 pa and 0.1 pa or more specifically “r” may be equal to 0.02 pa.

In general, in one aspect, an optical system including an image display panel and a 3D lens positioned in front of the image display panel. The 3D lens is curved in order to reduce the moiré effect between the image display panel and the 3D lens.

Implementations may include one or more of the following features. The sag of the 3D lens may be convex. The sag “s” in mm may follow the formula d/100 <s<d/30, where “d” is the diagonal size of the image display panel in cm. The image display panel may be pushed forward in the center of the image display panel to lessen or eliminate the concave curvature of the image display panel.

In general, in one aspect, a method of reducing moiré including the steps of generating an image from an image display panel, processing the image with an anti-moiré lens, and processing the image with a 3D lens.

In general, in one aspect, a method of reducing moiré including the steps of generating an image from an image display panel and processing the image with a 3D lens, where the curvature of the 3D lens is a convex curvature.

### BRIEF DESCRIPTION OF THE SEVERAL VIEWS OF THE DRAWING

FIG. 1A is a side view an LCD panel;

FIG. 1B is a front view of an LCD panel;

FIG. 2A is a back view of a lens assembly that includes a 3D lens and an anti-moiré lens;

FIG. 2B is a side view of a lens assembly that includes a 3D lens and an anti-moiré lens;

FIG. 3 is a side view of an optical assembly that includes an LCD panel and a lens assembly;

FIG. 4A is a back view of an anti-moiré lens;

FIG. 4B is a bottom view of an anti-moiré lens;

FIG. 5 is a bottom view of a lenticule from an anti-moiré lens;

FIG. 6A is a top view of a 3D lens;

FIG. 6B is a front view of a 3D lens;

FIG. 7 is a front view of pixels of an LCD panel;

FIG. 8A is a back view of flat plate with a step;

FIG. 8B is a bottom view of a flat plate with a step;

FIG. 9A is a back view of a convex plate with a step; and

FIG. 9B is a bottom view of a convex plate with a step.

FIG. 10 is a flowchart of a moiré reduction method using an anti-moiré lens.

FIG. 11 is a flowchart of a moiré reduction method using a curved 3D lens.

### DETAILED DESCRIPTION

Moiré patterns are formed when two periodic patterns beat against each other to form an additional pattern. In the case of a 3D display made from an LCD panel with a 3D lens in front of the LCD panel, moiré patterns may occur when the periodic pixel patterns of the LCD panel beat against the periodic pattern of the 3D lens. The moiré patterns may appear as linear bright and dark bands that move horizontally through the image when the viewer's head is moved horizontally. The period of the bands depends on the size of the display and the viewing distance, but is generally 2 to 10 cm when at typical viewing distance from displays that have a diagonal size of 100 cm to 150 cm (approximately 40 to 60 inches). The amplitude of intensity variation of the bands may be in the range of a few percent to 50% or more. In addition to linear bands, the moiré patterns may appear as circular patterns, a combination of circular and linear patterns, or as irregular patterns of various shapes.

LCD panels may use a variety of methods to reduce color shifting experienced by the viewer when viewed off axis. These methods may include sub-pixel patterns and multi-pixel patterns that constitute low-color-shift (LCS) technology. Although LCS panels may provide great benefit for 2D viewing, they generally increase moiré effects when coupled with a 3D lenticular lens. The technology of LCD panel switching may include multi-domain vertical alignment (MVA), in-plane switching (IPS), or other switching technologies. Certain switching technologies may increase moiré effects when coupled with a 3D lenticular lens or other optical element.

For the purpose of the following description, front is defined to mean the surface of the display that is facing towards the viewer, and back is defined to mean the surface of the display that is facing away from the viewer. Top is defined to mean the surfaces of the display that is facing up and bottom is the surface of the display that is facing down. Sides are defined to mean the surfaces that facing left and right relative to the viewer.

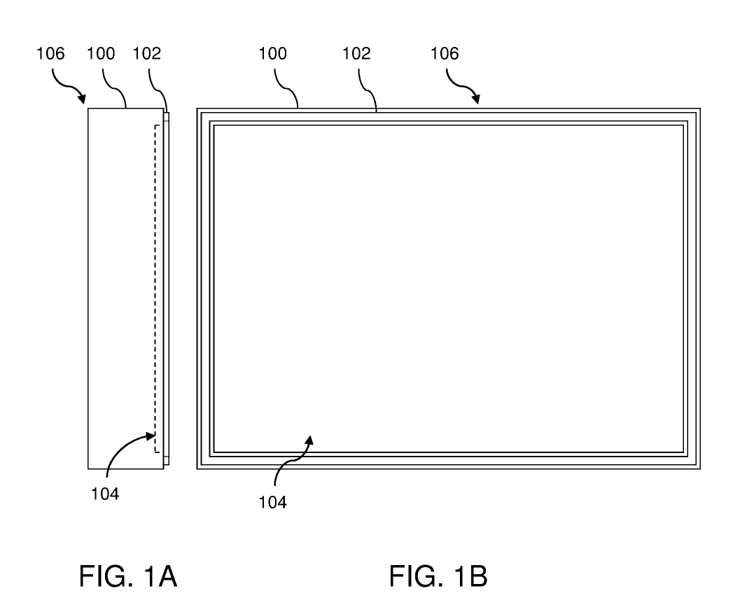

FIG. 1A shows a side view of LCD panel 106, and FIG. 1B shows a front view of LCD panel 106. Outside chassis 100 holds the parts of LCD panel 106. Image-forming face 104 of the LCD panel is recessed from the front face of outside chassis 100. Bonding material 102 forms a ring around the front, outside face of LCD panel 106. Bonding material 102 may be formed from strips of double-backed adhesive foam tape, or may be formed from any other adhesive material. Bonding material 102 may form a continuous ring, or may be formed from distinct segments placed around the front, outside face of LCD panel 106.

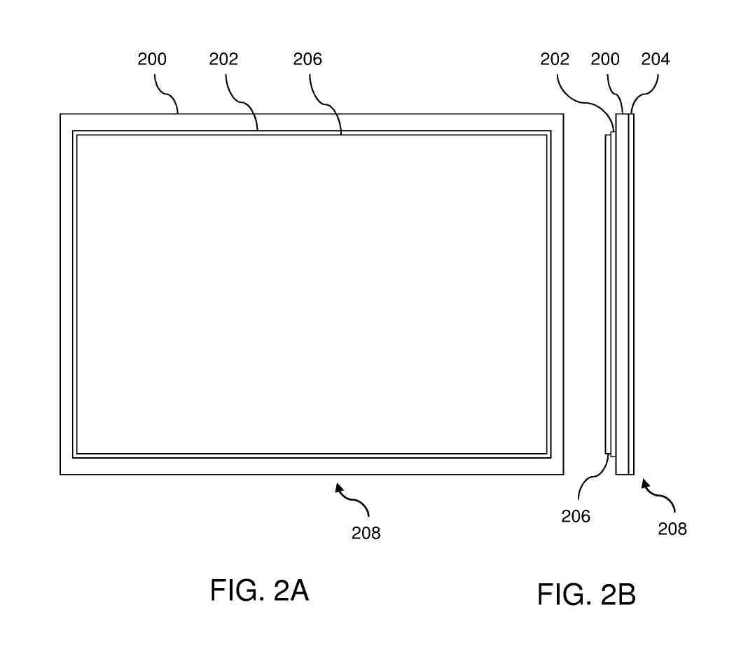

FIG. 2A shows a back view of lens assembly 208, and FIG. 2B shows a side view of lens assembly 208. Lens assembly 208 includes anti-moiré lens 206, plate 200, step 202, and 3D lens 204. 3D lens 204 is located in front of plate 200 and may be bonded to plate 200. Plate 200 is located in front of step 202. Anti-moiré lens 206 is located in back of step 202 and may be bonded to step 202. Plate 200 and step 202 may be constructed from one piece of rectangular parallelepiped material that is milled around the edge to form step 202, or plate 200 and step 202 may be separate pieces of rectangular parallelepiped material that are adhesively bonded together. Step 202 may be absent in which case anti-moiré lens 206 is bonded directly to plate 200. Plate 200 and step 202 may be glass, plastic, or other optically transparent material. Bonding may be performed using optically transparent pressure sensitive adhesive (PSA), optically transparent cement, or other optical bonding methods. 3D lens 204 and anti-moiré lens 206 may be lenticular lenses.

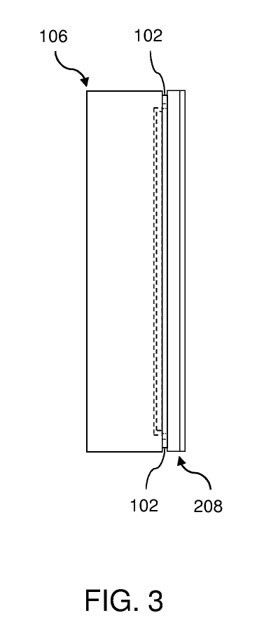

FIG. 3 shows a side view of an optical assembly that includes LCD panel 106 and lens assembly 208. Bonding material 102 holds together LCD panel 106 and lens assembly 208. Alternatively, instead of bonding material 102, there may be other features such as clamps or screws that hold together LCD panel 106 and lens assembly 208.

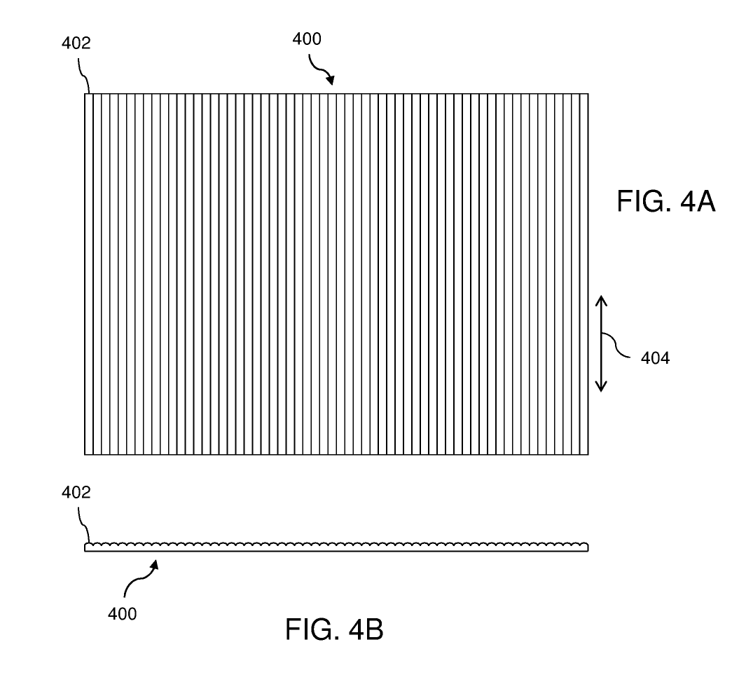

FIG. 4A shows a back view of anti-moiré lens 400, and FIG. 4B shows a bottom view of anti-moiré lens 400. Anti-moiré lens 400 is a sheet of many lenticules only one of which is shown as lenticule 402. Anti-moiré lens 400 may be formed from transparent plastic or glass or any other transparent optical material. Axis 404 defines the reference direction of the anti-moiré lens which is parallel to the direction of the lenticules.

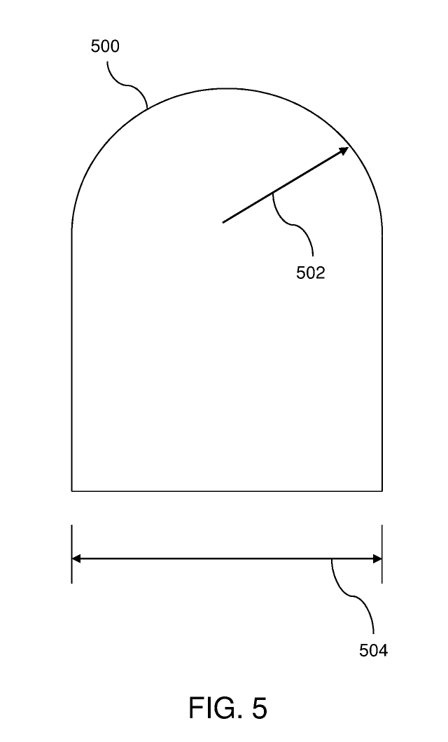

FIG. 5 shows a bottom view of lenticule 500 from an anti-moiré lens. The back surface of the lenticule has a convex curvature with radius 502. The convex curvature may be of cylindrical shape. Pitch 504 of the lenticule determines the spacing of the lenticules in the anti-moiré lens.

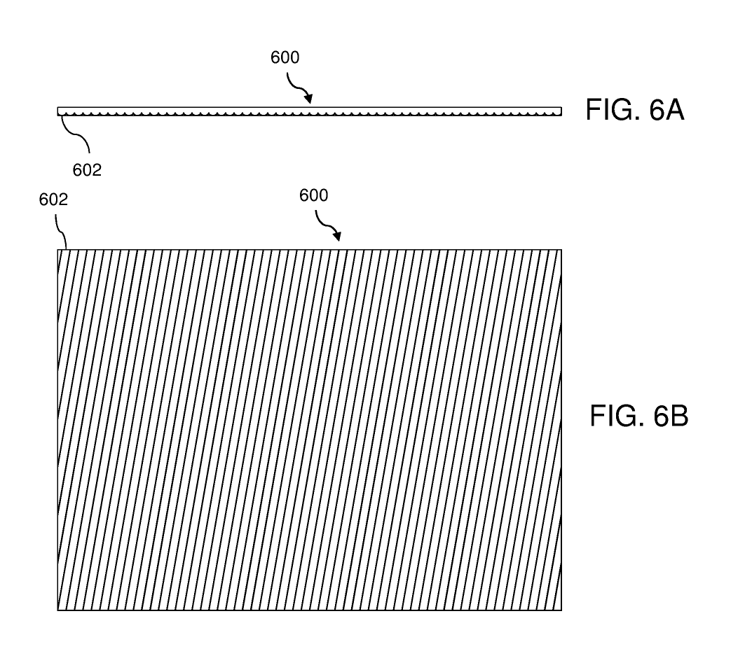

FIG. 6A shows a top view of 3D lens 600, and FIG. 6B shows a front view of 3D lens 600. 3D lens 600 is a sheet of many lenticules only one of which is shown as lenticule 602. 3D lens 600 may be formed from transparent plastic or glass or any other transparent optical material. 3D lens 600 may be designed according to the principles described in U.S. patent application Ser. No. 12/182869 filed Jul. 30, 2008, the complete disclosure of which is incorporated herein by reference.

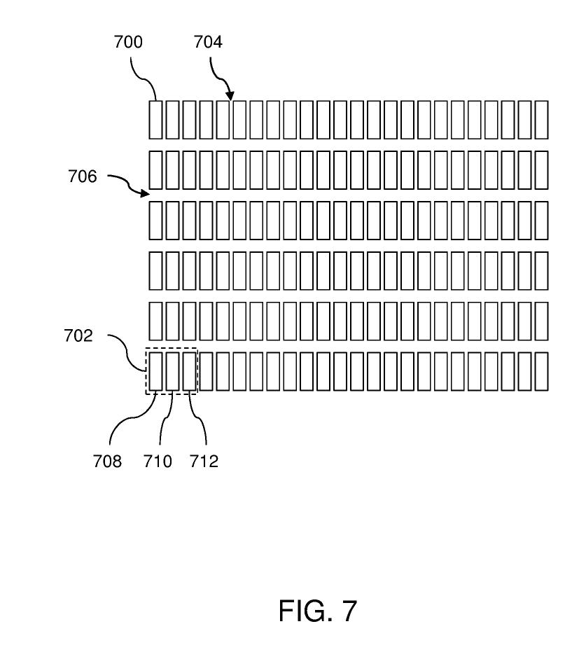

FIG. 7 shows a magnified view of sub-pixels on the image-forming surface of an LCD panel. Sub-pixel 700 is one of many sub-pixels which form a displayed image. In this example, three sub-pixels, red sub-pixel 708, blue sub-pixel 710, and green sub-pixel 712, form each complete pixel such as pixel 702. The gaps between sub-pixels have low reflection such that they form black lines between the pixels. As an example, vertical black line 704 and horizontal black line 706 are shown in FIG. 7. Horizontal black lines are typically thicker than vertical black lines. Moiré patterns may form between the black lines and the lenticules of the 3D lens. Alternatively the pixels may be formed from other combinations of sub-pixels such as two green sub-pixels, one red sub-pixel, and one blue sub-pixel.

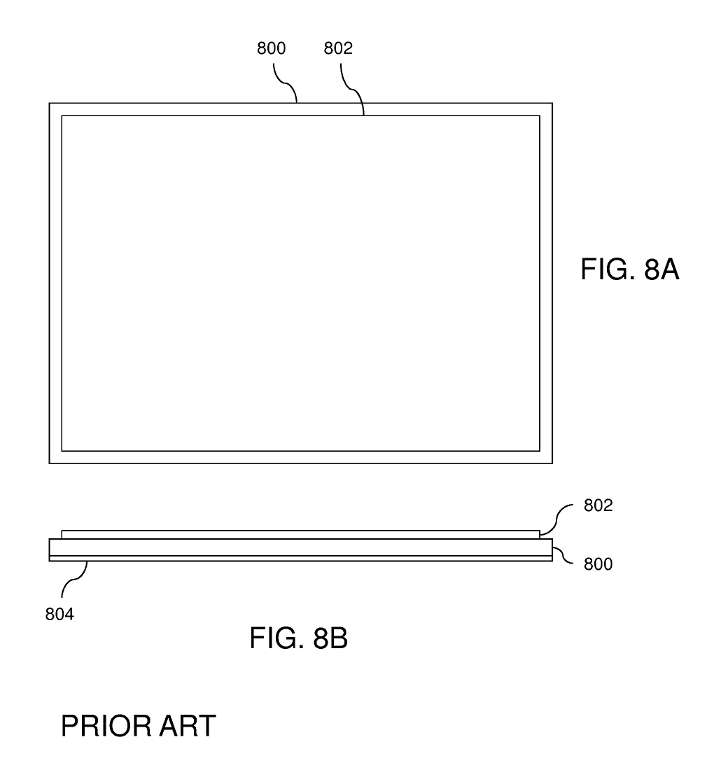

FIG. 8A shows a back view of flat plate 800 with step 802, and FIG. 8B shows a bottom view of flat plate 800 with step 802. FIGS. 8A and 8B represent prior art. When a 3D 804 lens is attached to the front of flat plate 800 and the resultant assembly is positioned in front of an LCD panel for 3D viewing, moiré patterns may result, especially if LCS technology is used in the LCD panel.

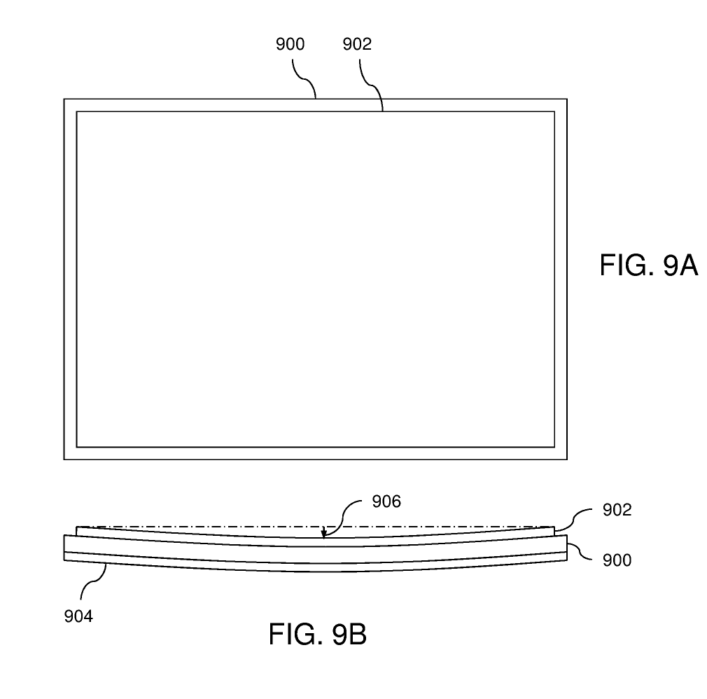

FIG. 9A shows a back view of convex plate 900 with convex step 902; and FIG. 9B shows a bottom view of convex plate 900 with convex step 902. Instead of flat plate 800 shown in FIGS. 8A and 8B, FIGS. 9A and 9B show convex plate 900. The curved shape of convex plate 900 guides 3D lens 904 into a curved shape that reduces any moiré effect that would otherwise form between the regular pattern of 3D lens 904 and the pixel patterns of an LCD panel. Sag 906 may be in the range of 1 to 5 mm for a display with a diagonal size in the range of 100 to 150 cm. The convex shape may be cylindrical or may be another curved shape such as spherical. In general, the magnitude of sag 904 in mm, denoted as “s”, may follow the relationship d/100<s<d/30 where “d” is the diagonal size of the display in cm. Experimental results show that a concave shape tends to increase the observed amount of moiré effect whereas a convex shape tends to decrease the observed amount of moiré effect.

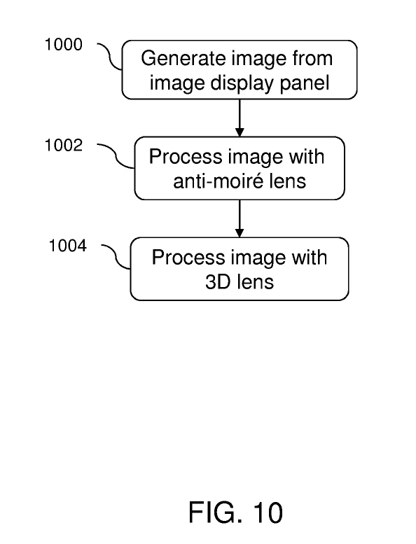

FIG. 10 shows a moiré reduction method using an anti-moiré lens. In step 1000, an image is generated by an image display panel. In step 1002, an image from an image display panel is processed by an anti-moiré lens. The processing includes optical refraction to change the direction of the light rays passing through the anti-moiré lens. In step 1004, the image from the image display panel is processed by a 3D lens after being processed by the anti-moiré lens.

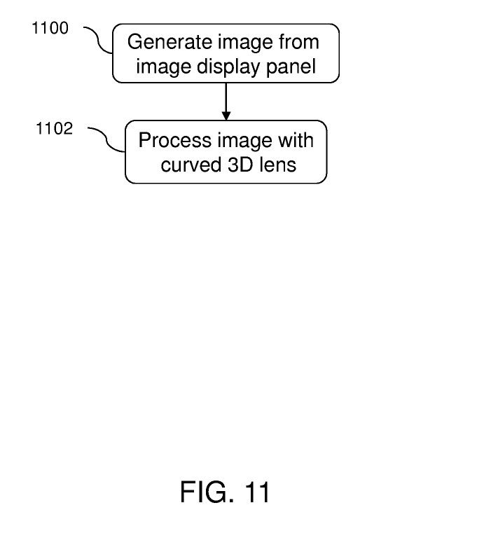

FIG. 11 shows a moiré reduction method using a curved 3D lens. In step 1100, an image is generated by an image display panel. In step 1102, the image from the image display panel is processed by a curved 3D lens.

The dimensions of the LCD panels may vary from handheld devices such as cell phones with diagonal sizes of only a few cm up to large LCD displays intended primarily for living rooms or advertising with diagonal sizes of 150 cm or more. Display resolutions may vary from 320×240 or smaller for cell phone displays up to 1920×1080 or larger for displays with diagonal sizes in the range of 100 to 150 cm. Common display aspect ratios of image width compared to image height are 4:3 or 16:9. The sizes of pixels and sub-pixels may be calculated from the diagonal size, aspect ratio, and resolution. Typical pixel pitches may be in the range of 100 microns to 1000 microns. For a 1920×1080 display with a 100 cm diagonal, the pixel pitch is approximately 500 microns. Sub-pixel sizes depend on how many sub-pixels are in each pixel. There are typically 3 to 10 sub-pixels per pixel. The LCD panel has layers of material in front of the actual formation region of the pixels. The front layers include color filter glass and polarizer that typically sum to approximately 0.5 mm for displays in the diagonal size range of 100 to 150 cm. Smaller displays may have thinner front layers and larger displays may have thicker front layers. The period of the moiré pattern that results from 3D lenses is related to the size of the LCD panel, resolution of the display, and pitch of the 3D lens.

The optimum pitch and radius of the anti-moiré lens depend on each other and on the size of the display. If the pitch is too small, or the radius too large, there may be insufficient reduction of moiré. If the pitch is too large, or the radius too small, there may be undesirable side effects such as degradation of resolution or introduction of additional moiré patterns. In general the radius “r” in microns may follow the formula r=0.02 pa where “p” is the pixel pitch and “a” is the anti-moiré pitch in microns. For example, a display with a pixel pitch of 500 microns and an anti-moiré pitch of 100 microns, the radius may be 1000 microns. The satisfactory operational range of r may follow the formula 0.004 pa<r<0.1 pa. The thickness of the anti-moiré lens is not critical when the anti-moiré lens is positioned on the back of the plate. A thickness range of approximately 75 microns to 300 microns is typically convenient to fit into the space between the plate and the imaging surface of the LCD panel.

A gap is desirable between the anti-moiré lens and the image forming surface of the LCD panel to prevent Newton's rings or other artifacts from optical contact. The thickness of the air gap may be in the range of 0.5 mm to 2 mm for displays in the diagonal size range of 100 to 150 cm. Smaller displays may have air gaps that are smaller than 0.5 mm and larger displays may have air gaps that are larger than 2 mm.

The thickness of the step at the edge of the plate depends on the front frame thickness of the LCD panel. The primary purpose of the step is to provide the proper thickness of optical material between the 3D lens and the LCD pixel location. Another purpose of the step is to position the anti-moiré lens close to the LCD pixel location. The thickness of the step may be in the range of 0.5 mm to 2 mm for displays in the diagonal size range of 100 to 150 cm. Smaller displays may have steps that are smaller than 0.5 mm and larger displays may have steps that are larger than 2 mm.

If the LCD panel is concave, there may be increased moiré patterns between the LCD panel and 3D lens. By pushing the LCD panel slightly forward in the center, the concave curvature of the LCD panel may be lessened. By pushing with sufficient force, the LCD panel may become flat or even slightly concave. The reduction or elimination of concave curvature of the LCD panel may lessen the moiré pattern, especially when combined with a convex 3D lens.

The applied angle orientation of the lenticules in the 3D lens may be as described in U.S. patent application Ser. No. 12/182869. The orientation of the reference direction of the anti-moiré lens may be vertical or substantially vertical (within±10 degrees of vertical). In other words, the lenticules may be oriented so that they are running vertically. Additional moiré patterns may form if the orientation of the anti-moiré lens is not optimal. Since the horizontal pixel gaps are typically larger than the vertical pixel gaps, it might be supposed that a horizontal orientation of the anti-moiré lens would be more effective in reducing moiré patterns, but experimental results show that a vertical orientation of the anti-moiré lens is generally more effective.

Various features of the anti-moiré lens may be randomized reduce moiré patterns between the anti-moiré lens and the other system elements. Features that may be randomized include the pitch, radius, and shape of the anti-moiré lens. Randomization may be in one dimension only, or may be in two or three dimensions. Any random feature or combination of random features may be used to create a random array for the anti-moiré lens. The randomization may be of two levels, for example two different radii randomly distributed, or may be of more than two levels. Only slight randomization of a variable may be sufficient to help reduce moiré. A change of plus and minus 10% may be sufficient. For example, if the average radius is 1000 microns, half of the lenticules may have a radius of 900 microns and half of the lenticules may have a radius of 1100 microns. The satisfactory operational range of the average radius “r” in microns may follow the formula 0.004 pa<r<0.1 pa, where “p” is the pixel pitch in microns, and “a” is the average anti-moiré lens pitch in microns.

The anti-moiré lens may be attached to the image forming surface of LCD instead of the step. In this case, the thickness of the anti-moiré lens sets the spacing between the anti-moiré lenticules and the pixels. Alternatively, the anti-moiré lens may be located in front of the 3D lens rather than behind it as long the anti-moiré lens does not substantially interfere with the operation of the 3D lens.

The lenticules may be other shapes besides lenticular. For example, flat surfaces tilted at a slight angle with respect to the plane of the display may be used. In this case, the angle may be in the range of 0.5 to 5 degrees which is small enough to prevent loss of resolution, but large enough to slightly shift the apparent position of the pixels and thereby reduce moiré patterns.

In addition to LCD panels, other image display panels may be subject to moiré patterns, especially when coupled with a 3D lens. The apparatus and methods described in this disclosure may be utilized for plasma displays, rear projection displays, light emitting diode (LED) displays, laser phosphor displays (LPD), cathode ray tube (CRT) displays, front-projection displays, organic light emitting diode (OLED) displays or any other image display panel which has pixels that may form moiré patterns.

3D lenses may be formed from lenticular lenses, parallax barriers, waveplates, tunable lenses, or any other device that sends one image to one eye and another image to the other eye for autostereoscopic viewing. The image sent to each eye may depend on the viewing position. In the case of stereoscopic systems which have multiple viewing zones, the pixels may be arranged by a software algorithm as described in U.S. patent application Ser. No. 12/182869.

Various types of optical elements may also form moiré patterns when placed in front of image displays. For example flip lenses, lenses which guide light to multiple viewers, magnification lenses, or fiber optic light guides may have optical features which beat with the pixels of the image display to form moiré patterns. In particular, periodic optical elements may have periodic features which may form moiré patterns.

Plates and steps may be formed as rectangular parallelepipeds, or may fit the shape of the display by being curved, cut-out, or angled.

Transparent optical materials such as polycarbonate, acrylic, or UV-cure resin may be used for the anti-moiré lens, 3D lens, plate, and step. Slight haze in any of these layers may be beneficial to reduce moiré as long as the desired resolution is still achieved.

Multiple layers of anti-moiré lenses may be used such that the net effect of all layers are sufficient to reduce moiré patterns to an acceptable level. For example, two layers of anti-moiré lenses, each having a pitch of 50 microns, may have approximately the same total moiré reduction as one layer of anti-moiré lens having a pitch of 100 microns. Any number of layers may be used to control the anti-moiré effect so that moiré is reduced to the desired level. The applied angle orientation of each layer may be vertical, or the applied angle of each layer may be oriented at a variety of different angles.

Other implementations are also within the scope of the following claims.

What is claimed is:

1. An optical system comprising:
an image display panel; and
an anti-moiré lens positioned in front of the image display panel;
wherein the anti-moiré lens comprises a lenticular lens.

2. The system of claim 1 further comprising an optical element positioned in front of the anti-moiré lens.

3. The system of claim 2 wherein the optical element is a periodic optical element.

4. The system of claim 2 wherein the optical element comprises a 3D lens.

5. The system of claim 4 wherein the 3D lens comprises a lenticular lens.

6. The system of claim 4 wherein the anti-moiré lens is laminated to the back of a plate and the 3D lens is laminated to the front of the plate.

7. The system of claim 1 wherein the image display panel comprises a liquid crystal display.

8. The system of claim 1 wherein the anti-moiré lens comprises a periodic array of lenticules, wherein the lenticules have a radius “r” in microns and a pitch “a” in microns, the image display panel has a pixel pitch “p” in microns, and 0.004 pa<r<0.1 pa.

9. The system of claim 8 wherein r=0.02 pa.

10. The system of claim 8 wherein a reference direction of the anti-moiré lens is oriented substantially vertically.

11. The system of claim 1 wherein the anti-moiré lens comprises a periodic array of lenticules, wherein each lenticule has a flat surface, and each flat surface has an angle in the range of 0.5 to 5 degrees.

12. The system of claim 1 wherein the anti-moiré lens comprises a random array of lenticules, wherein the lenticules have an average radius “r” in microns and an average pitch “a” in microns, the image display panel has a pixel pitch “p” in microns, and 0.004 pa<r<0.1 pa.

13. The system of claim 12 wherein r=0.02 pa.

14. An optical system comprising:
an image display panel; and
a 3D lens positioned in front of the image display panel;
wherein the 3D lens is curved in order to reduce a moiré effect between the image display panel and the 3D lens.

15. The system of claim 14 wherein a sag of the 3D lens is convex.

16. The system of claim 14 wherein d/100<s<d/30, where “s” is the sag in mm, and “d” is a diagonal size of the image display panel in cm.

17. The system of claim 14 wherein the image display panel is pushed forward in a center of the image display panel to lessen or eliminate a concave curvature of the image display panel.

18. A method of reducing moiré comprising:
generating an image from an image display panel;
processing the image with an anti-moiré lens; and
processing the image with a 3D lens.

19. A method of reducing moiré comprising:
generating an image from an image display panel; and
processing the image with a 3D lens;
wherein a curvature of the 3D lens is a convex curvature.
